(19) United States
(12) Patent Application Publication
(10) Pub. No.: US 2016/0328798 A1
(43) Pub. Date: Nov. 10, 2016

(54) Monitoring and Adjusting Behavior of Electronic Trading Algorithms

(71) Applicant: Edge Financial Technologies, Inc., Bartlett, IL (US)

(72) Inventor: Jitesh Thakkar, Bartlett, IL (US)

(21) Appl. No.: 15/148,874

(22) Filed: May 6, 2016

Related U.S. Application Data
(60) Provisional application No. 62/158,530, filed on May 7, 2015.

(51) Int. Cl. G06Q 40/04; G06Q 30/02; G06Q 40/06

(52) U.S. Cl. CPC G06Q 40/04; G06Q 40/06; G06Q 30/0201

(57) ABSTRACT

A plurality of parameters associated with a trading algorithm is monitored. Based on the monitoring, a determination is made whether the plurality of parameters associated with the trading algorithm satisfies a trigger. A message is sent to a trading algorithm and one or more of a trading platform and an exchange to adjust orders associated with the trading algorithm.

### CROSS REFERENCE TO RELATED APPLICATION

This disclosure claims the benefit of priority under 35 U.S.C. §119(e) to U.S. Provisional Application No. 62/158,530 entitled “KillSwitchPlus” filed on May 7, 2015, the contents of which is hereby incorporated by reference in its entirety.

### BACKGROUND

Financial trading has evolved from a manually intensive process to a technology enabled process. With the advent of electronic trading, a trader can be in direct contact with a financial market from anywhere in the world performing near real-time transactions without a need to make personal contact with a broker.

Electronic trading is generally based on linking a trading platform to an exchange. The trading platform is a computer system which allows traders to place orders for financial trades of stocks, bonds, derivatives, and other instruments. The exchange acts as a market for buyers and sellers of the instruments, examples of which may be the New York Stock Exchange, Nasdaq, or Tokyo Exchange. Typically, a trader may log into the trading platform, create an electronic order, and place the electronic order with one or more exchanges via the trading platform. Further, the trading platform may monitor the execution of the electronic order via a drop copy of the executed order provided by the exchange.

A recent advent in electronic trading is use of trading algorithms. Trading algorithms are computer programs which generate and place orders for financial trades at a speed and frequency that is impossible for a human to mimic. Because of this speed, orders placed by trading algorithms capitalize on rapid price changes in traded instruments as opposed to orders entered by a human. However, trading algorithms come with significant risk. Trading algorithms are only as good as the human who designed it and the programmer who implemented it. Programming errors, algorithm errors, technical glitches and market events unfamiliar to the trading algorithm can result in erroneous placement of financial orders, inadvertent trading losses and imposition of regulatory fines, A trading algorithm that is behaving abnormally is called a runaway trading algorithm.

### OVERVIEW

Runaway trading algorithms are financial trading programs that erroneously generate and place orders for financial trades of stocks, bonds, derivatives, and other instruments to an exchange such as the New York Stock Exchange or Nasdaq. The runaway trading algorithms may erroneously generate and place orders with the exchange for financial trades a result of algorithmic errors, programming errors, market conditions, and the like. The runaway trading algorithm may continue to place such orders unless checks are put in place to detect the runaway trading algorithm. Disclosed herein are innovations related to aspects of electronic trading, including mechanisms for protecting against financial loss and/or avoiding regulatory fines due to runaway trading algorithms.

A trading algorithm may generate financial orders. The financial orders may be instructions to conduct a financial transaction such as a sale or purchase of a security, commodity, derivative, and other financial instrument. These financial orders may be sent to an exchange for execution, and the exchange may generate drop copies. The drop copies are near real time reports of trades related to the financial orders. The financial orders and drop copies may have one or more parameters indicative of the behavior of the trading algorithm, e.g., a sell price and buy price of an instrument and a bid price and ask price of the instrument. Various statistics, e.g., a mean, median, standard deviation, may be determined for the one or more parameters over a period of time. The statistics may be indicative of a normal behavior of the trading algorithm.

A determination may be made based on the one or more parameters that the trading algorithm is behaving abnormally. The trading algorithm may be behaving abnormally if one or more triggers is satisfied. In one example, the trigger may be satisfied if the one or more of the parameters exceeds a threshold. In another example, the trigger may be satisfied if a logical condition associated with the one or more parameters is satisfied. In yet another example, the trigger may be satisfied if one or more parameters satisfies a pattern indicative of a runaway trading algorithm.

Financial orders associated with the trading algorithm may be adjusted as a result of determining that the trading algorithm is behaving abnormally. The adjustment may be made at various levels. For example, the adjustment may be made at the trading algorithm level such that the trading algorithm itself adjusts orders associated with the trading algorithm. As another example, the adjustment may be made at the trading platform level such that the trading platform adjusts orders associated with the trading algorithm. As yet another example, the adjustment may be made at the exchange level, such the exchange may adjust order associated with the trading algorithm. The adjustment may take a variety of forms including cancelling financial orders associated with the trading algorithm, cancelling all orders associated with the trading algorithm that increase a position in an instrument, and therefore increase risk of loss, and issuing orders associated with the trading algorithm to zero out a position in an instrument, among others.

One of ordinary skill in the art will appreciate these as well as numerous other aspects in reading the following disclosure.

In one embodiment, a method may comprise monitoring a plurality of parameters associated with a trading algorithm; based on the monitoring, determining whether the plurality of parameters associated with the trading algorithm satisfies a trigger; and based on the plurality of parameters satisfying the trigger, sending to the trading algorithm and one or more of a trading platform and an exchange a message to adjust orders associated with the trading algorithm. The message may be an indication to prohibit orders by the trading algorithm which increase risk of loss and allow orders by the trading algorithm which decrease risk of loss. Sending a message to a trading algorithm may comprise adjusting the orders associated with the trading algorithm while not adjusting orders of other trading algorithms. The message may cause a state of the trading platform to change from a trading allowed state to a limited trading state. Sending, via the network interface, to the trading algorithm and one or more of the trading platform and the exchange a message may comprise sending a message to the trading platform to cancel orders associated with the trading algorithm or liquidate positions of an account associated with the trading algorithm; setting a timer; determining that the timer expired; and based on the determination that the timer expired, disabling a type of trading associated with the trading algorithm. The trigger may be satisfied when the plurality of parameters associated with the trading algorithm matches a predetermined pattern. The trigger may be satisfied when the plurality of parameters associated with the trading algorithm is outside a range defined by a low value and a high value. The plurality of parameters outside the range may comprise the plurality of parameters being outside the range by at least one standard deviation. Sending, via the network interface, to the trading algorithm and one or more of the trading platform and the exchange a message may comprises sending a first message to the trading algorithm, the first message instructing the trading algorithm to cancel orders or liquidate instrument (e.g., securities) of an account associated with the trading algorithm; setting a timer; determining that the timer expired and a position of the account associated with the trading algorithm is non-zero; and based on determining that the timer expired and the position of the account associated with the trading algorithm is non-zero, sending a second message to zero out the position of the account; and disabling a type of trading associated with the trading algorithm. The method may facilitate customization of actions associated with the adjusting of the orders for an account. The message to adjust orders may cause any new orders to be not sent to the exchange. Sending, via the network interface, to the trading algorithm and one or more of the trading platform and the exchange a message may comprises sending the message to a pre-trade risk check of the trading platform. The message may alter one or more pre-trade risk limits.

In another embodiment, a network device may comprise a network interface for communicating via a communication network with a trading platform, trading algorithm, and exchange; and a processor comprising instructions, which when executed, cause the processor to: monitor, via the network interface, a plurality of parameters associated with the trading algorithm; based on the monitoring, determine whether the plurality of parameters associated with the trading algorithm satisfies a trigger; and based on the plurality of parameters satisfying the trigger, send, via the network interface, to the trading algorithm and one or more of the trading platform and the exchange a message to adjust orders associated with the trading algorithm. A message may be an indication to prohibit orders by the trading algorithm which increase risk of loss and allow orders by the trading algorithm which decrease risk of loss. The message may cause a state of the trading platform to change from a trading allowed state to a limited trading state. The instructions for sending, via the network interface, to the trading algorithm and one or more of the trading platform and the exchange a message may comprise: sending a message to the trading platform to cancel orders associated with the trading algorithm or liquidate positions of an account associated with the trading algorithm; setting a timer; determining that the timer expired; and based on the determination that the timer expired, disabling a type of trading associated with the trading algorithm. The trigger may be satisfied when the plurality of parameters associated with the trading algorithm matches a predetermined pattern. The instructions for sending, via the network interface, to the trading algorithm and one or more of the trading platform and the exchange a message may comprise: sending a first message to the trading algorithm, the first message instructing the trading algorithm to cancel orders or liquidate instruments (e.g., securities) of an account associated with the trading algorithm; setting a timer; determining that the timer expired and a position of the account associated with the trading algorithm is non-zero; and based on determining that the timer expired and the position of the account associated with the trading algorithm is non-zero, sending a second message to zero out the position of the account; and disabling a type of trading associated with the trading algorithm. The network device may comprise instructions for facilitating customization of actions associated with the adjusting of the orders for an account. The trigger may be satisfied based on the time of day and/or calendar date. The message may include an indication to adjust orders based on a time of day and/or calendar date. The trigger may be based on market conditions. The message may include an indication to adjust orders based on risk.

### BRIEF DESCRIPTION OF THE DRAWINGS

FIG. 1 depicts an example network configuration in which example embodiments may be implemented.

FIG. 2 depicts a more detailed example network configuration in which example embodiments may be implemented.

FIG. 3 depicts an example network configuration associated with pre-trade processing in which example embodiments may be implemented.

FIG. 4 depicts an example network configuration associated with post-trade processing in which example embodiments may be implemented.

FIG. 5 is a flow diagram of example functions associated with an example risk control engine.

FIG. 6 is a flow chart of example functions associated with adjusting orders.

FIG. 7 is a more detailed flow chart of example functions associated with adjusting orders.

FIG. 8 is another more detailed flow chart of example functions associated with adjusting orders.

FIGS. 9A, 9B, 9C, and 9D illustrate example user interfaces associated with an example risk control engine.

FIG. 10 is a flow chart of example functions associated with adjusting orders.

### DETAILED DESCRIPTION

The following disclosure makes reference to accompanying figures and several exemplary scenarios. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which may be contemplated herein. The following description may further reference examples. It should be understood that this is done merely for sake of clarity and explanation and is not meant to be limiting.

I. Example Configuration

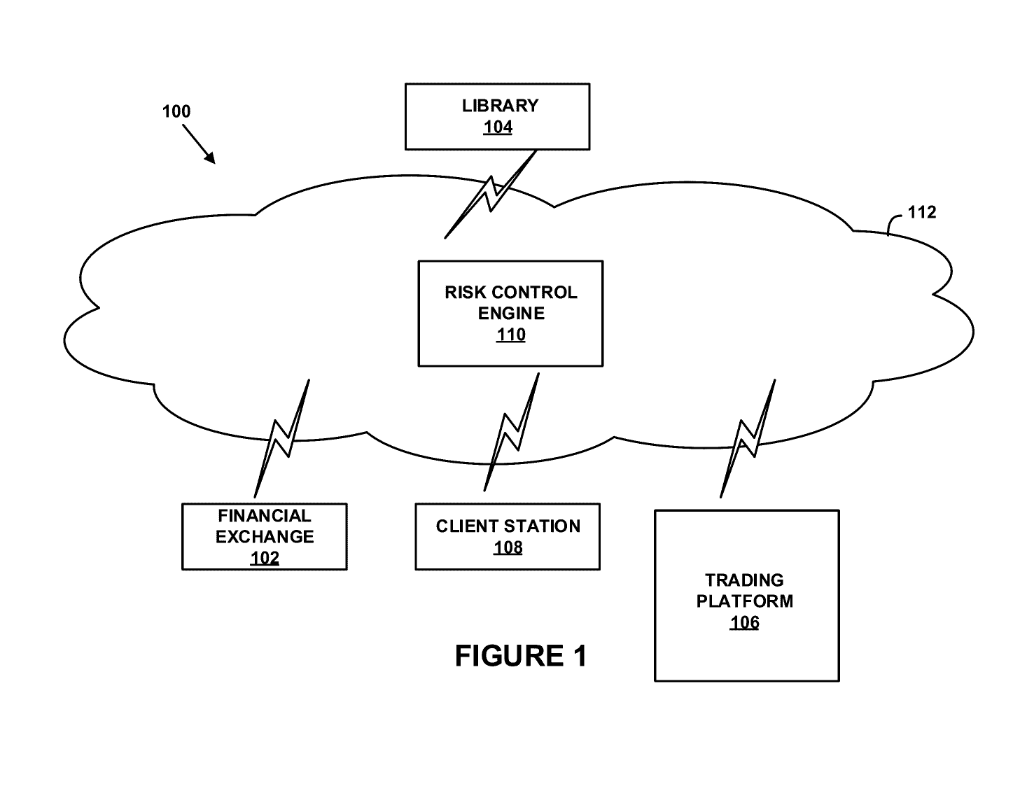

FIG. 1 illustrates a financial trading system in accordance with exemplary embodiments. The financial trading system may be composed of various network systems, including a financial exchange 102, a library 104, a trading platform 106, a client station 108, and a risk control engine 110. Each network system may have a network interface. The network interface enables the network system to connect to a communication network 112 which facilitates communication among the network systems. The communication network 112 may be wired connections such as a Tl or ISDN line or wireless connections through common network components such as high-speed servers, routers, gateways and the Internet.

The financial exchange 102 (also referred to herein as “exchange”) may be a marketplace that bring buyers and sellers together to trade securities, commodities, derivatives, and other financial instruments. The financial exchange 102 may typically include a collection of computer systems to facilitate the trading between buyer and sellers. Examples of such financial exchanges may include the New York Stock Exchange, Chicago Mercantile Exchange, Nasdaq, and Tokyo Stock Exchange.

The library 104 may be a database which stores financial orders and/or drop copies of financial transactions. Financial orders may be transactions which are to be executed by the financial exchange. For example, the order may be to sell or purchase a security, commodity, derivative, and other financial instrument. The orders may take a number of forms. A market order is an order to conduct a transaction at the current market price. A limit order is an order to conduct a transaction at a stated price or better. A stop order is an order to conduct a transaction at the best available price after a certain stated price is reached. Finally, a stop-limit order is a stop order that becomes a limit order when the stated price (known as the stop price) is reached. The order may have been generated at the trading platform, e.g., by a trading algorithm, and provided via the communication network 112 to the database of the library for storage. On the other hand, the drop copies may be near-real time copies of trades which have been executed by the financial exchange. The drop copies may include information such as an order fill, trade confirmation, details of a trade such as profit and loss, or termination of orders. In some cases, the drop copies may include information which is duplicative of the financial order. The library 104 may receive the drop copies from the exchange via the communication network 112 and store the drop copies received from the financial exchange in its database.

The financial order and drop copies may indicate an account associated with the financial order or drop copy. Additionally, or alternatively, the financial order and drop copies may identify a user associated the financial order or drop copy. The user could be a holder of the account or a trader who placed the order. Still additionally, or alternatively, the order and drop copies may identify a group associated with the financial order or drop copy. The group may be those users or accounts with a specific risk profile or certain preferences such as trading based on particular trading algorithm, manual trading, or frequency of trading. Additionally, or alternatively the order and drop copies may indicate a firm (e.g., accounts of the firm) such as a brokerage associated with the financial order or drop copy. Still additionally, or alternatively the order and drop copies may indicate a trading algorithm associated with the financial order or drop copy.

The trading platform 106 may be computer system which allows traders to place financial orders with financial exchanges. The trading platform 106 may take a variety forms. The trading platform may be an off-the-shelf software developed by an independent software vendor (ISV) and provided direct to traders. Trading Technologies, Inc. is an example of such an ISV trading platform. Alternatively, the trading platform may be a proprietary system, e.g., created by a firm, for use by the firm and other authorized users for trading of instruments. In some embodiments, a trading algorithm may be running on the trading platform 106. In other embodiments, the trading algorithm may be running on a computer system remote to the trading platform 106, but communicatively coupled to the trading platform via the communication network 112.

The client station 108 may be a computer system which transmits and receives via the communication network 112 information between the components of the trading system. The information may be associated with financial orders, including financial orders that have been placed, financial orders which have been executed, profits associated with trades, and losses associated with trades. Further, the client station 108 may have a user interface. For example, the user interface may be a display screen which displays the information associated with financial orders. The information may be presented on the display screen at different levels of granularity. For example, the information associated with financial orders may be presented for each user and/or for each account of the user. Additionally, or alternatively, the information may be aggregated and presented for a group or groups of users or accounts. A group may have certain common preferences. The preferences may be specific risk profiles or preferences such as using manual traders, setting behavior/profiles of algorithms, or using high frequency traders. Still additionally or alternatively, the information presented may be associated with a firm.

In addition to the display screen, the user interface may have a mechanism for receiving user input from a user. The user interface may take the form of a keyboard, mouse, or voice, for example. The input may be, for example, to set various triggers based on information presented on the display screen associated with financial orders. The triggers may be conditions, if satisfied, result in an action being taken respect to financial orders.

The risk control engine 110 may be a computer platform which monitors and manage behavior of a trading algorithm. The behavior may be based on various risks including market risk, financial risk, account risk, system risk, and technology risk, among others. Market risk relates to changes in prices of instruments which may result in financial loss. Financial risk relates to changes in margin requirements and changes to financial regulations which may result in financial loss. Account risk relates to changes in positions an account or related accounts which may result in financial loss. System risk and technology risk relates to changes in external platform operation (e.g., exchange platform) and internal platform operation (e.g., trading platform) which may result in financial loss. The risk control engine 110 may be communicatively coupled to the library 104, trading platform 106, and client station 108 via the communication network 112. In some embodiments, the risk control engine 110 may receive, from the library 104, financial orders generated by the trading algorithm and drop copies associated with the financial orders. In other embodiments, the risk control engine 110 may receive the financial orders from the trading platform 106 and drop copies from the financial exchange 102.

The risk control engine 110 may determine whether a trading algorithm is operating abnormally and adjust orders associated with the trading algorithm so as to reduce financial loss. For example, the risk control engine 110 may adjust orders associated with a trading algorithm prior to the orders being executed by the exchange 102. As another example, the risk control engine 110 may adjust orders associated with a trading algorithm based on executed orders of the exchange 102.

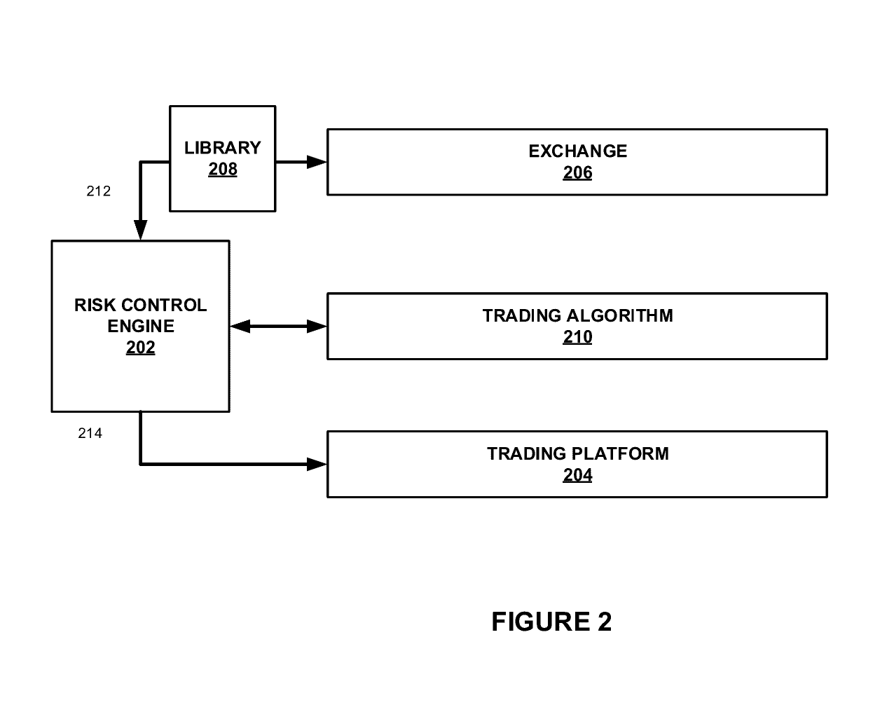

FIG. 2 illustrates the arrangement of the risk control engine 202, trading platform 204, exchange 206, and library 208 in accordance with embodiments. The risk control engine 202 may be coupled to the library 208 via a communication link 212. Additionally, the risk control engine 202 may be coupled to the trading platform 204 via a communication link 214. The risk control engine 202 may receive via the library 208 financial orders and/or drop copies, and based on the financial orders and/or drop copies adjust orders associated with a trading algorithm at various levels. The adjustment may be made at the trading algorithm 210 such that the trading algorithm itself adjusts orders associated with the trading algorithm. The adjustment may be made at the trading platform 204 such that the trading platform adjusts orders associated with the trading algorithm. This adjustment may be different from adjustments to the trading algorithm 210 itself which may also run on the trading platform 204. The adjustment may be made at the exchange 206, such the exchange 206 may adjust order associated with the trading algorithm.

Additionally, or alternatively, the risk control engine 202 may receive financial orders from from the trading algorithm 210, and based on the financial orders adjust orders associated with a trading algorithm 210 at various levels. The levels may include adjusting the orders at the trading algorithm 210 itself, the trading platform 204, and/or the exchange 206.

The adjustment at the various levels may provide varying level of control of the orders sent to the exchange 206. Adjusting orders associated with the trading algorithm at the trading algorithm 210 itself may be a fine control of how the trading algorithm 210 generates orders itself. For example, this fine control may be for the trading algorithm not to send buy orders. On the other hand, adjusting orders associated with a trading algorithm at the trading platform 204 or at the exchange 206 may be a blunt control. For example, the blunt control could be setting a trading state. The trading state may define what types of orders are sent to the exchange 206 or whether orders are sent to the exchange 206. As another example, the trading state may define whether the exchange 206 executes or blocks a particular order. As yet another example, the trading state may define whether certain types of orders, e.g., cancel orders, are sent to the exchange 206 by the the trading platform 204. The risk control engine 202 may adjust the orders at a plurality of levels, e.g., trading algorithm, trading platform, exchange, depending on what functionality is supported at each level to effect the desired adjustment to orders associated with a trading algorithm.

In some embodiments, the adjusting orders associated with the trading algorithm at the trading algorithm itself may not be limited to fine control. The adjusting may also be a blunt control as provided by the changing of the trading state. Other arrangements are also possible.

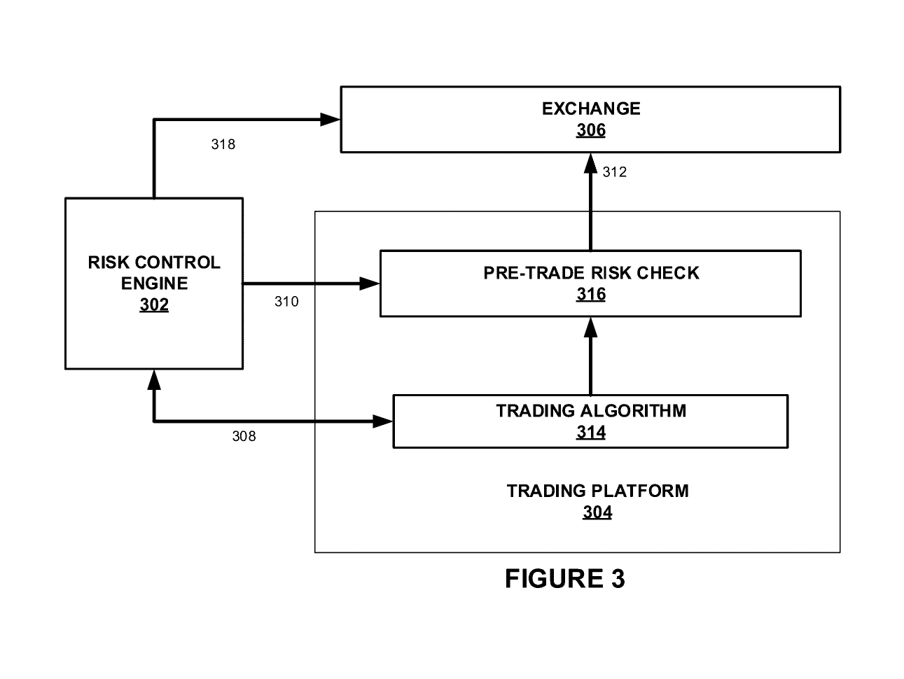

FIG. 3 illustrates an arrangement of the risk control engine 302, trading platform 304, and exchange 306 when orders associated with a trading algorithm 314 are adjusted prior to the orders being executed by the exchange 306. The risk control engine 302, trading platform 304, and exchange 306, may be coupled via one or more communication links 308-312, e.g., wired or wireless connections, which facilitate transmitting and receiving information associated with adjusting of the orders.

The trading platform 304 may have a trading algorithm 314 and a pre-trade risk check 316. The trading algorithm 314 may generate orders. The pre-trade risk check 316 may be a hardware and/or software module which checks certain parameters of financial orders prior to releasing the financial order to the exchange 306 via link 312 and also controls whether trading is allowed or a limited type of trade is permitted. The pre-trade risk check 316 may check parameters such as change credit limits, max position size, max order size, etc. For example, if an order placed by the trading algorithm is 100 shares and a max order size is 90 shares, then the pre-trade risk check 316 may not pass the order to the exchange 306. The pre-trade risk check 316 may also be able to control a trading state for a user, account, group, or firm. For example, the trading may be blocked for certain accounts. The pre-trade risk check 316 may perform other functions as well.

FIG. 3 shows that the trading platform 304 includes the pre-trade risk check 316. In some embodiments, the pre-trade risk check 316 may be separate from the trading platform 304. The pre-trade risk check 316 may be a computer system separate from the trading platform 304, but communicatively coupled to both the trading platform 304 and the exchange 306. The pre-trade risk check 316 may be a third party system to the trading platform 304.

The risk control engine 302 may receive directly from the trading algorithm 314 financial orders generated by the trading algorithm 314 via link 308. The risk control engine 302 may then compare parameters of the financial orders to various triggers which if satisfied cause the risk control engine 302 to adjust orders associated with the trading algorithm 314. For example, a trigger may be that a parameter associated with a financial order exceeds a threshold. If the parameter exceeds the threshold, then the risk control engine 302 may determine that the trading algorithm 314 is not behaving normally. Alternatively, the trigger may be a logical condition being satisfied, such as a certain number of orders placed in a particular time by a trading algorithm 314. If the certain number of orders are placed in a particular time by the trading algorithm 314, then the risk control engine 302 may determine that the trading algorithm 314 is not behaving normally.

Still alternatively, the trigger may be to detect a certain pattern. Using pattern recognition and/or neural networks, the risk control engine 302 may learn a trading algorithm's normal behavior (e.g., what types of positions the algorithm typically takes, how many orders are submitted per minute, number of instruments in which there are positions, number of consecutive orders are sent, quantity of orders over a time period (quantity of orders per minute, per 5 mins, 10 mins), notional value of positions, etc.). The risk control engine 302 may then look for activity that appears abnormal relative to the trading algorithm's “normal behavior.” The abnormal behavior may be indicative of the trading algorithm 214 being a runaway trading algorithm.

The risk control engine 302 may then adjust orders associated with the trading algorithm 314 when the trigger is satisfied. Via link 308, the risk control engine 302 may cause the trading algorithm 314 itself to adjust the orders. Additionally, or alternatively, via link 310, the risk control engine 302 may cause the trading platform 304, e.g., pre-trade risk check 316, to adjust orders associated with the trading algorithm 314. Still additionally, or alternatively, the risk control engine 302 may cause the exchange to adjust orders via link 318. The risk control engine 302 may also adjust a trading state or parameters of the pre-trade risk check 316, trading algorithm 314, and/or exchange.

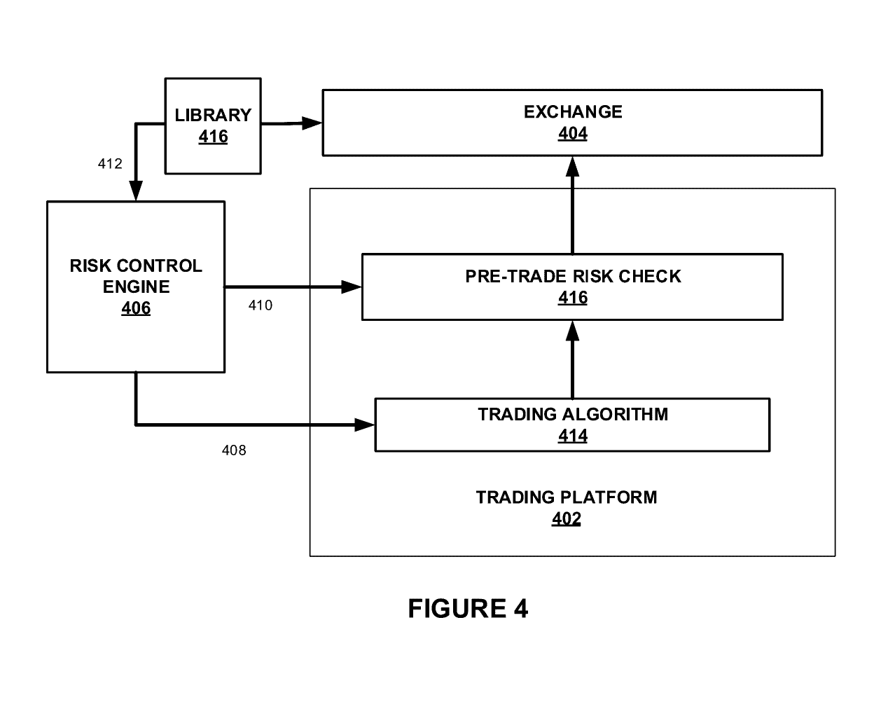

FIG. 4 illustrates the arrangement of the trading platform 402, exchange 404, and risk control engine 406 when orders associated with a trading algorithm are adjusted based on executed orders of the exchange 404. The trading platform 402, exchange 404, and risk control engine 406 may be coupled via one or more communication links 408-412 which facilitate exchange of information associated with the adjusting of the orders.

Again, the trading platform 402 may have a trading algorithm 414 and a pre-trade risk check 416. The risk control engine 406 may receive from the library 416, via link 412, or directly from the exchange (not shown), drop copies of orders executed by the exchange 404. The drop copies may include various parameters associated with execution of financial orders. The risk control engine 406 may then compare parameters of the drop copies to the various triggers which if satisfied cause the risk control engine 406 to adjust orders associated with the trading algorithm 414. For example, via link 408, the risk control engine 406 may cause the trading algorithm 414 to adjust the orders. Additionally, or alternatively, via link 410, the risk control engine 406 may cause the trading platform 414, e.g., pre-trade risk check 416, to adjust orders associated with the trading algorithm 414. Still additionally, or alternatively, the risk control engine 402 may cause the exchange 404 to adjust orders. The risk control engine 402 may also adjust a trading state or parameters of the pre-trade risk check 416, trading algorithm 414, and/or exchange 404.

In some embodiments, the trading platform might not have a pre-trade risk check. The trading algorithm may send orders directly to the exchange. In this case, the risk control engine may adjust orders associated with the trading algorithm by causing the trading algorithm to adjust orders and/or causing the exchange to adjust orders. Other arrangements are also possible.

II. Example Operation

The configuration depicted in FIG. 1-4 will now be discussed in further detail below. To help describe some of these operations, functional block diagrams may be referenced. In some cases, each block may represent a module or portion of program code that includes instructions that are executable by a processor to implement specific logical functions or steps in a process. The program code may be stored on any type of computer-readable medium, such as non-transitory computer-readable media. In other cases, each block may represent circuitry that is wired to perform specific logical functions or steps in a process. Moreover, the blocks shown in the flow diagrams may be rearranged into different orders, combined into fewer blocks, separated into additional blocks, and/or removed based upon the particular embodiment.

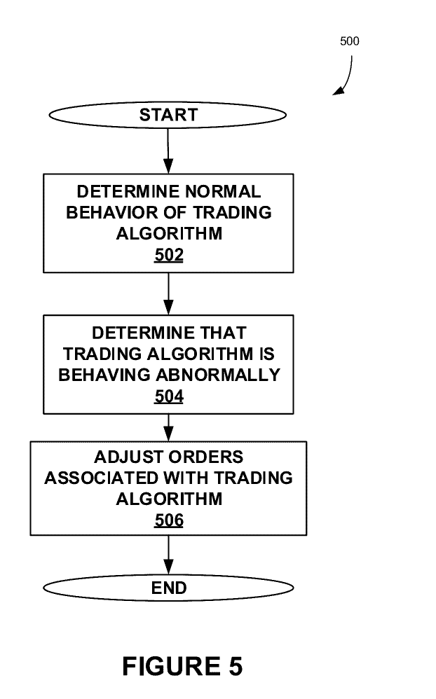

FIG. 5 is a flow chart of functions associated with monitoring and adjusting orders associated with a trading algorithms as a result of inadvertent financial losses being incurred by the trading algorithm, e.g., a runaway trading algorithm. In some embodiments, the functions may be performed by the risk control engine. In other embodiments, the functions may be performed by one or more of the risk control engine, the trading platform, the client station, or the exchange. Other arrangements are also possible.

Briefly, at 502, a normal behavior of a trading algorithm may be determined. For example, one or more parameters associated with financial orders placed by a trading algorithm and drop copies may indicate whether the trading algorithm is behaving normally. At 504, a determination is made that the trading algorithm is behaving abnormally. For example, triggers may be satisfied indicative of the trading algorithm behaving abnormally. At 506, orders associated with the trading algorithm are adjusted as a result of determining that the trading algorithm is behaving abnormally.

Referring back to FIG. 5, at 502, a normal behavior of a trading algorithm may be determined. The financial orders and drop copies associated with trading algorithm that is stored in the library may be indicative of this normal behavior. The financial orders and drop copies may include parameters such as an order count, profit or loss (P&L) over a period of time, orders per day, P&L, orders per minute, orders per second, P&L change per minute, number of consecutive orders, total quantity of new orders sent within specified time period, etc. The values of these parameters assessed over a period of time may indicate a normal behavior of the trading algorithm. Additionally, or alternatively, the normal behavior of the trading algorithm may be characterized by a mean, median, standard deviation, threshold, and/or a high value and low value for one or more parameters of the financial orders and drop copies associated with a trading algorithm over a period of time. Still additionally, or alternatively, pattern recognition or neural networks may be able to learn a trading algorithm's normal behavior patterns, e.g., what types of positions the algorithm typically takes, how many orders are submitted per minute, number of instruments in which there are positions, number of consecutive orders are sent, quantity of orders over a time period (quantity of orders per minute, per 5 minutes, 10 minutes), maximum position, maximum order size, notional value of positions, etc.

In some instances, the trading algorithm may not act in a manner consistent with the normal behavior. In this case, the trading algorithm may be a runaway trading algorithm. At 504, a determination is made that the trading algorithm is behaving abnormally. Among others, the abnormal behavior may be as a result of a programming error, an algorithmic error, or market conditions which may be incompatible with the trading algorithm. The abnormal behavior may subject a user, account, group of users or accounts, and/or firm to financial losses.

Various triggers based on market conditions may be indicative of abnormal behavior. For example, the trigger may be a relationship between a parameter and a threshold. The parameter may be associated with a financial order and/or drop copy received from the library. The threshold may be predefined value and/or customizable value for a trading algorithm, the account associated with the trading algorithm, the user associated with the trading algorithm, the group associated with the trading algorithm, the firm associated with the trading algorithm, etc. In some cases, the trigger may be satisfied if the parameter meets a threshold. For example, if the parameter is an order count and the threshold is a certain order count, then the trigger may be satisfied if the order count is greater than the threshold. The trading algorithm may not be behaving normally. In other cases, the trigger may be satisfied if the parameter does not meet the threshold.

Alternatively, the trigger may be that a logical condition is satisfied. The logical condition may be composed of two or more conditions connected by logical operators, such as an AND or OR operator. Based on whether the logical condition is true or false, the trigger may be satisfied. For example, if an order count is greater than a threshold (or x standard deviations higher than “normal”), and P&L is decreasing over a period of time, and losses exceeds a certain threshold, then the logical condition is satisfied and the trading algorithm may not be behaving normally. The logical condition may be associated with a trading algorithm, an account associated with the trading algorithm, a user associated with the trading algorithm, a group associated with the trading algorithm, a firm associated with the trading algorithm, etc.

Still alternatively, a trigger may be that a behavior of the trading algorithm is not indicative of normal behavior patterns. The library may store a history of financial orders and drop copies for the trading algorithm. The history may be indicative of normal behavior. For example, the normal behavior patterns may be defined by a low and high range of the parameters of the financial orders and drop copies for the trading algorithm for a period of time, and the mean, median, and standard deviation of the parameters for the period of time. Using this range and statistics, a neural network may suggest setting thresholds “n” standard deviations away, outside the normal range (outside the high and low) for various parameters of the financial orders and/or drop copies associated with the trading algorithm. If one or more of the thresholds are exceeded, then trading algorithm may not be operating normally.

For example, if the orders per minute range over a period of time is set to 0 to 150, if the trading algorithm begins to send 220 orders per minute, then the threshold is exceeded and the trading algorithm may not be behaving normally. As another example, if the position range over a period of time is −2000 to +3200 for one particular instrument, a position of +6000 may cause the trigger to be satisfied.

If the parameters associated with a financial order and/or drop copies includes one or more of a bid price, ask price, and bid/ask spread, then the trigger may be a pattern of buying or selling of instruments by the trading algorithm with respect to one or more of these parameters. The bid/ask price may indicate the price at which the instrument was last bought/sold at, e.g., defines the price of an instrument paid by a seller/buyer in the marketplace. The trigger may be satisfied if the buying and selling matches the pattern.

One example of the pattern may be the trading algorithm selling an instrument at or below the ask price and buying an instrument at or above the bid price, and more than simply a sale or purchase of securities at a same price or a same quantity. Another example of the pattern may be consecutive or non-consecutive buying and selling of the instrument. Yet another example of the pattern may be an amount that the instrument is bought or sold for, e.g., 1 tick or multiple ticks. An example of the pattern may be the buying and selling of the instrument being within a certain period of time. Another example of the pattern may be a quantity and variation in quantity in the buying and selling of the instrument for the certain period of time. Yet another example of the pattern may be a number of buys and sells for the certain period of time. An example of the pattern may be a buying of an instrument at a higher price than a selling of an instrument which results in a consistent loss. The pattern may also include one or more of these examples.

Consider an instrument with a bid price of 2091.50 and an ask price of 2092.00. If an order to sell is at 2091.25, then the sale crosses the market, because the sale is less than the ask price, and is flagged. Alternatively, consider an instrument with a buy at 2092.25. The buy also crosses the market because the buy is more than the bid price, and is flagged. Still alternatively, consider an instrument with a buy at 2091.75. The buy does not cross the market because it is less than the ask price, and is not flagged. In general, buying or selling of an instrument should be less than and greater than the bid/ask price or at least equal to the bid/ask price. A pattern deviating from this behavior may cause a trigger to be satisfied which is indicative of a runaway trading algorithm.

Yet another trigger may be based on an interaction between the trading algorithm and a user. Some trading algorithms may operate for long periods of time. A trading algorithm may be configured to periodically request a user to provide an indication. The indication may be a command, login, or phrase. A user is monitoring the trading algorithm as long as an indication is being received. If no indication is provided for a threshold period of time, then the trading algorithm may be considered to be behaving abnormally and the trigger may be satisfied.

In some examples, the trigger may also be associated with a time. If a logical condition, pattern, or threshold is satisfied, the trigger may not be satisfied unless the time associated with the trigger is also satisfied. The time may be a time of day and/or a calendar day. For example, the trigger may be associated with a time of day such as 1 pm to 3 pm. In this example, the trigger may be satisfied when the time is also 1 pm to 3 pm even if the logical condition, pattern, or threshold is satisfied at different times.

At 506, in response to detecting abnormal behavior, orders associated with the trading algorithm may be adjusted to reduce risk. Various reasons may exist for effecting the adjustment, including adjusting orders to reduce losses associated with the trading algorithm or adjusting orders to satisfy certain margin requirements such as available funds or minimum funds.

The risk control engine may adjust the orders associated with the trading algorithm based on various levels of granularity. For example, instead of blocking communications over the communication link between the trading platform and exchange, which may affect trading of multiple users and accounts, the orders of a trading algorithm may be adjusted, the orders associated with both the trading algorithm and an account may be adjusted, the orders associated with both the trading algorithm and a user may be adjusted, the orders associated with both the trading algorithm and a group of users or accounts may be adjusted, or the orders associated with both the trading algorithm and a firm may be adjusted.

The adjustment may take a variety of forms as well. For example, the adjustment may be to cancel or halt orders associated with a trading algorithm. The adjustment may be made for one trading algorithm or a plurality of trading algorithms. As another example, operation of the trading algorithm may be adjusted thus changing the orders generated by the trading algorithm. The adjustment may be made for a user, account, group of users, or firm associated with the trading algorithm.

In some embodiments, the adjustment may be made based on a time. The time may be a time of day and/or a calendar day. For example, the time associated with the adjustment may be a time of day such as 1 pm to 3 pm. In this example, the orders may be adjusted only when the time is also 1 pm to 3 pm even if the trigger is satisfied at different times.

In some embodiments, the adjustment may be effected by changing a trading state of the trading algorithm, the trading platform, and/or the exchange. Trading state may be indicated by a flag or state variable accessible to the risk control engine trading platform. Orders associated with a trading algorithm are sent to the exchanges based on the trading state. For example, the pre-trade risk check of the trading platform is allowed to send orders associated with a trading algorithm to the exchange only if the state permits.

The trading state may include the Trading Allowed state, Trading Disabled, Trade Out Only, or TradeOutAndCancelOrders. The trading state may change from one of these states to another of the Trading Allowed state, Trading Not Allowed state, Trade Out Only state, or TradeOutAndCancelOrders state.

A normal state may be Trading Allowed. In this state all types of trades may be permitted by the trading algorithm.

In some embodiments, the trading state may change from Trading Allowed to Trading Disabled. In the Trading Disabled State, no new orders, no cancel orders, and no modification of existing orders is permitted. For example, the orders are adjusted to stop sending new orders, stop cancelling orders, and stop modifying of existing orders. Further, a network port or a network connection to the exchange may be blocked and/or the trading platform may be shut down so that orders are not sent over the communication network.

In another embodiment, the trading state may change from Trading Allowed to TradeOutOnly. TradeOutOnly is a state where all orders that increase positions, and therefore increase risk of loss, may be canceled but order are not cancelled or modified that (if filled) would decrease risk of loss or flatten the position. In this regard, the risk control engine may keep track of positions for each account. If the order in the market (if filled), would move that position towards zero, then that order is not deleted. Further, if the working order is larger than existing position, then a change/modify order would be sent to reduce the quantity of working order to match the position. The orders closest to the “last traded price” would be left working, other orders would be cancelled/deleted.

For example, account ABC associated with a trading algorithm may be long 100 position on Emini S&P December 2015 future, and short 200 position on Emini Nasdaq December 2015 contract, and long 500 MSFT stock. If the trading state is changed to TradeOutOnly and there are buy and sell working orders for Emini S&P December 2015 futures, then all buy orders would be cancelled; the sell orders would be cancelled if quantity exceeds the long position, e.g., 100, sell orders of quantity 100 closest to the market/ last traded price would not be cancelled, but left in the market as working orders.

In yet another embodiment, the trading state may change from Trading Allowed to TradeOutAndCancelOrders where no new orders are accepted and no existing orders are modified but existing orders may be cancelled. In this regard, any orders associated with the trading algorithm would not be sent to the exchange.

In view of the trading state, a harsh control or soft control may be associated with the adjustment of orders. The trading state may be changed at the exchange, the trading platform, the pre-trade risk check, or at the trading algorithm itself. The harsh control may be, for example, that a trading state is changed from Trading Allowed to Trading Disabled. On the other hand, a soft control may be, for example, that a trading state is changed from Trading Allowed to Trade Out Only or TradeOutAndCancelOrders.

A mechanism for adjusting the orders associated with the trading algorithm via a trading platform may depend on a form that the trading platform takes.

When the trading platform takes the form of an ISV trading platform, the ISV trading platform may support a library of APIs accessible to the risk control engine. The library of APIs may be native to the ISV trading platform or may have been made available through a API plug-in. The APIs allow the risk control engine to control order flow from the trading platform to the exchange. The control may be of the trading algorithm, trading platform, and/or exchange.

For example, the risk control engine may send, via the API, a message to the trading platform to cancel any orders not yet executed (i.e., working orders) in an account associated with the trading algorithm. In another example, the risk control engine may send, via the API, a message to the trading algorithm to liquidate positions in the account associated with the trading algorithm. The liquidation may be effectively sending orders to the trading platform to cause instruments associated with the account to be traded for cash or cash equivalents. In yet another example, the risk control engine may send, via the API, a message to change a trading state.

The risk control engine, via the API, may communicate with the trading platform, and maintain a heartbeat message to ensure a communication link is active. The risk control engine, via the API, may perform other checks on orders placed to the exchange such as fat finger checks, order size limits, position size limits, orders per seconds, orders per 5 seconds, and allowed number of consecutive orders sent for the same instrument, same quantity, or same order type.

When the trading platform takes the form of a proprietary trading platform, the proprietary trading platform may support the library of APIs accessible to the risk control engine as described above with respect to the ISV. In some cases, however, the proprietary trading algorithm may not support an API. Instead, a software agent application may perform functions on behalf of the risk control engine to adjust orders associated with a trading algorithm in a manner similar to that of using APIs.

The risk control engine may make adjustments at various levels of granularity. All the orders associated with a trading algorithm may be adjusted, the orders associated with both the trading algorithm and an account may be adjusted, the orders associated with both the trading algorithm and a user may be adjusted, the orders associated with both the trading algorithm and a group of users or accounts may be adjusted, or the orders associated with both the trading algorithm and a firm may be adjusted. Other combinations are also possible.

Further, the adjustments described herein may be made at various layers, e.g., an exchange level, trading platform level, and/or trading algorithm level. Orders associated with the trading algorithm itself may be adjusted at the exchange. Orders associated with the trading algorithm may be adjusted at the trading platform. This adjustment may be different from adjustments to the trading algorithm 210 itself which may also run on the trading platform 204. For example, the orders may be adjusted at the pre-trade risk check. Orders associated with the trading algorithm may be adjusted at the exchange.

The adjustment at the various levels may ensure adjusting of an order based on supported adjustments provided at each level before being executed by the exchange. For example, a trading algorithm may support an action to not send buy orders and this can be adjusted. As another example, a trading platform may only support certain states for adjustment of orders such as Trading Enabled and Trading Disabled per Account or Per User. Another, trading platform may support no states but only control of an order size limit. On the other hand, an exchange may allow for blocking orders and cancelling orders. As a result, adjusting the orders associated with a trading algorithm may require adjustments at one or more of the trading algorithm, trading platform, and exchange level depending on desired results. The adjustments may be made via an API and/or a software agent application.

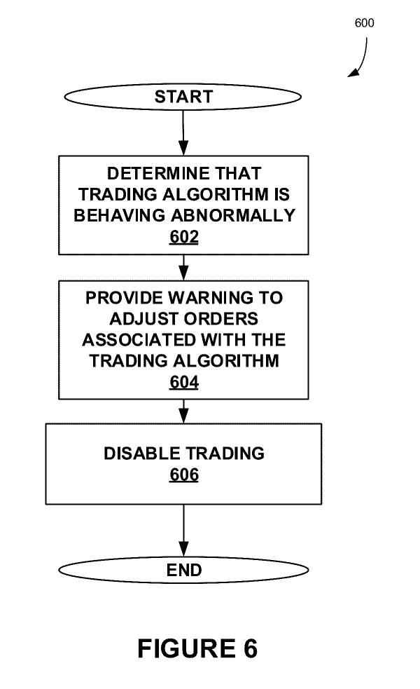

FIG. 6 is a flow chart of example functions associated with adjusting orders. The functions may be performed by one or more components of the financial trading platform, such as the risk engine.

At 602, a trading algorithm may be determined to be behaving abnormally. For example, parameters of a financial order and/or drop copy may be compared to a trigger which if satisfied is indicative of abnormal behavior. At 604, a warning may be provided. The warning may be an indication to the trading algorithm itself to adjust orders, the trading platform (e.g., to the pre-trade risk check) to adjust orders associated with the trading algorithm, and/or the exchange to adjust orders associated with a trading algorithm. For example, the warning may be an indication that a positon size is exceeded, a P&L is exceeded, or an order count is exceeded. Further, the warning may indicate a time limit to perform the adjustment. The time limit may be a fixed amount of time for the trading platform, trading algorithm, and/or exchange to take action. The actions may include cancelling orders and/or liquidating accounts to avoid further losses. Then, at 606, trading may be disabled so that further losses not incurred. The trading may be disabled for one or more accounts, users, groups, and/or firms associated with the trading algorithm. For example, positions may be zeroed out and/or an account may be disabled.

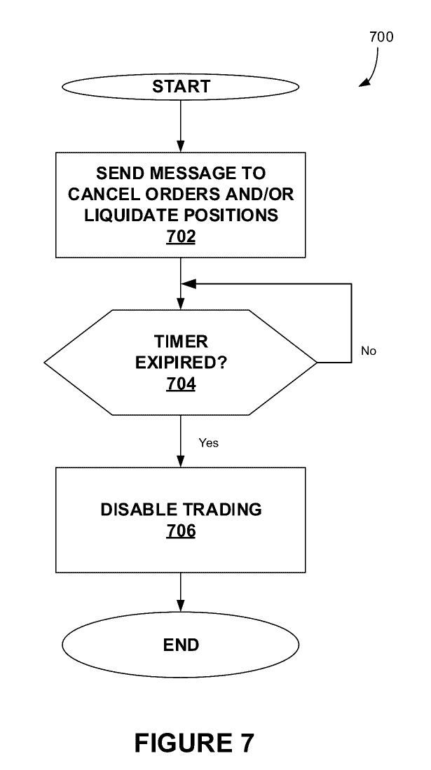

FIG. 7 is a more detailed flow chart of example functions associated with adjusting orders of a trading algorithm. At 702, the risk control engine may send, via an API or software agent application, a message to the trading platform to cancel orders associated with an account of a trading algorithm not yet executed (i.e., working orders) by the trading platform. Additionally, or alternatively, the risk control engine may send, via an API or software agent application, a message to the trading platform to liquidate orders associated with an account of a trading algorithm. The liquidation may result in the instruments associated with the account traded for cash or cash equivalents. In this regard, financial exposure of an account, user, group etc. may not increase.

A timer may also be established for the trading platform to complete the cancellation of orders and/or liquidation. The timer may give the trading platform time, e.g., 1 minute, to complete the liquidation. At 704, a determination may be made as to whether a certain time has passed, e.g., 1 minute. If the timer expires, then at 706 the risk control engine may send a message, via an API or software agent application, to disable trading. For example, the pre-trade risk check may prevent any orders associated with the account associated with the trading algorithm to be sent to the exchange. Alternatively, the pre-trade risk check may set order size limits to zero for the account.

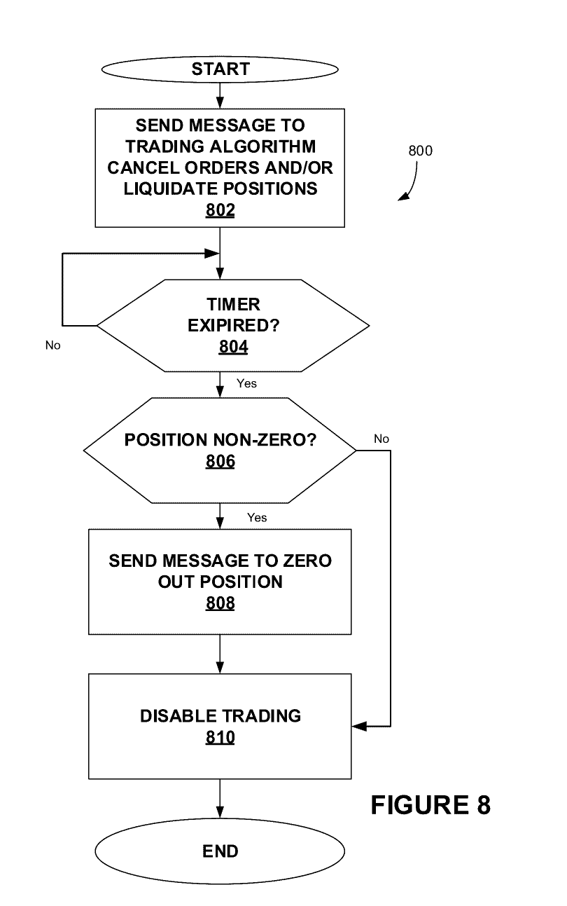

FIG. 8 is another more detailed flow chart of functions associated with adjusting orders of a trading algorithm. The adjustment of orders may begin at 802 by sending a message to the trading algorithm to begin one or more of a liquidation and/or cancellation of working orders, e.g., those which reduce risk (all orders that increase positions, and therefore increase risk of loss, may be canceled but order are not cancelled or modified that (if filled) would decrease risk of loss or flatten the position) so that an an account, user, group, and/or firm associated with the trading algorithm achieves a “zero position”. The zero position is when an account is neither long or short in an instrument, e.g., have no position in an instrument. Further, a timer may be established to give the trading algorithm time to liquidate and/or send cancellation orders, e.g., 1 or 2 minutes. If, at 804, the allowed time expires, e.g., 1 or 2 minutes, and if, at 806, the position is non zero, then the trading algorithm may not have responded to the message at 802. At 808, the risk control engine may send a message to the trading platform to zero out a position. The position may be zeroed out for an account, user, group, and/or firm. Further, at 810, a message is sent to the trading platform to disable trading. The trading may be disabled for an account, user, group, and/or firm associated with the trading algorithm. Additionally, or alternatively, the trading may be disabled only for a certain type of instrument.

Other arrangements are also possible for when liquidating orders and/or cancellation orders are sent. In some embodiments, a message to disable an account may be sent before liquidating orders and/or cancellation orders are sent. Such an action may be taken when a priority is to prevent “risky orders” or “risk increasing orders” from reaching the exchange. In other embodiments, a timer may not be used and/or ignored after liquidating orders and/or cancellation orders are sent until a zero position is achieved for an account. Such an action may be taken when the priority is to have a “zero position” for the account.

In embodiments, a customization process may also be carried out. The customization process may involve defining actions to be taken by a risk control engine when a trading algorithm is behaving abnormally. The actions may be defined prior the trading algorithm generating orders for a user, account, group, or firm. This way the user, account holder, group, and/or firm can approve the actions to be taken in the event the trading algorithm behaves abnormally. Additionally, or alternatively, thresholds, logical conditions, and patterns may be also adjusted during the customization process so as to control when abnormal behavior by a trading algorithm is triggered.

The certification process may involve simulating a liquidation of the account and monitoring and recording the liquidation. The thresholds can be evaluated and potentially adjusted until the liquidation process is acceptable. A user may then sign off on the thresholds. Then, the risk control engine may be activated for real-world trading with the approved triggers. This way the user controls how and when an order of a trading algorithm is adjusted.

In addition to adjusting the orders of a trading algorithm, notifications may be sent indicative of the trading algorithm operating abnormally. The notifications may be sent to one or more of the trading platform, client station, and exchange. The notification may take the form of an alert which causes a pop-up message in a browser or an email that is sent to an email account. Further, the notification may be both audible as well as visual.

In some embodiments, the adjustment of the orders associated with the trading algorithm may be based on a level of a parameter associated with the trading algorithm and nearness to a threshold. For example, a parameter associated with the trading algorithm may be, e.g., 70%, 80%, or 90% of the threshold that triggers a determination that the trading algorithm is operating abnormally. Based on the nearness to the threshold, corresponding adjustments to the orders associated with the trading algorithm may be taken to reduce financial loss. As the nearness of the threshold increases, more drastic adjustments may be taken to reduce financial loss. The adjustments may include one or more of stop sending new orders, send new orders to flatten positions (zero out positions), request cancel of all working orders, request to cancel working orders that increase risk, leave working orders that decrease risk, do not send any new orders or modify order requests, fat finger checks, order size limit, position size limit, orders per second, orders per 5 seconds, allowed number of consecutive orders sent for the same instrument, of same quantity and order type. Such adjustments may be performed via the API or the software agent application.

These adjustments may be applied in a variety of ways. For example, new orders associated with a trading algorithm may not be sent to the exchange when a breach is at 70% of a threshold, and new orders to flatten positions (zero out positions) may be sent when a breach is at 80% of a trigger. At 90%, the risk control engine may give the trading algorithm a finite amount of time (“X” minutes) to liquidate all positions of an account associated with the trading algorithm. If after this amount of time, the position is non zero, then the risk control engine may flatten the position associated with the account (zero out the position). In this regard, the risk control engine may communicate with the trading algorithm, via the software agent application or API, notifying it that the algorithm has breached thresholds and algorithm now has certain amount of time (x minutes) to liquidate all its positions. If after the time limit passes (“X” minutes), the positions are not flat, then the risk control engine may take action, via an API or a software agent application, to cause the trading platform to liquidate the position on behalf of the trading algorithm.

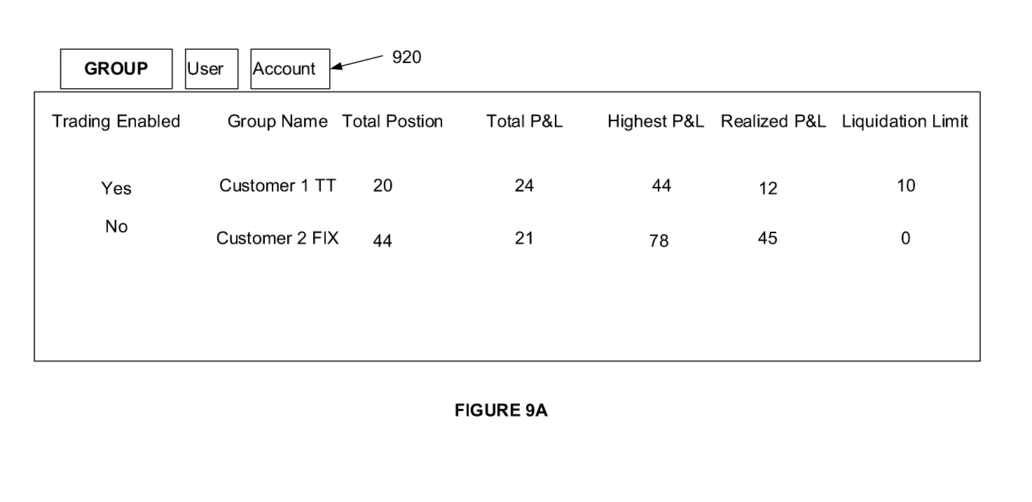

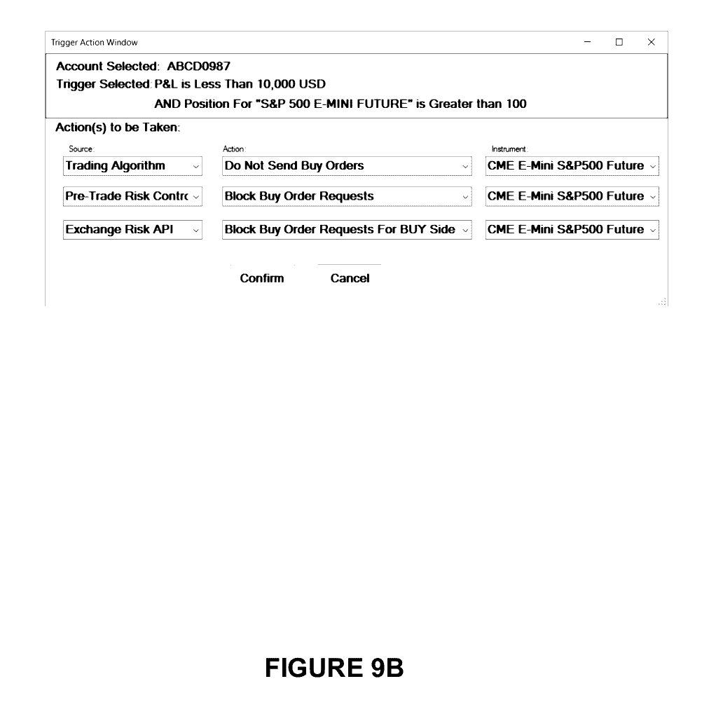

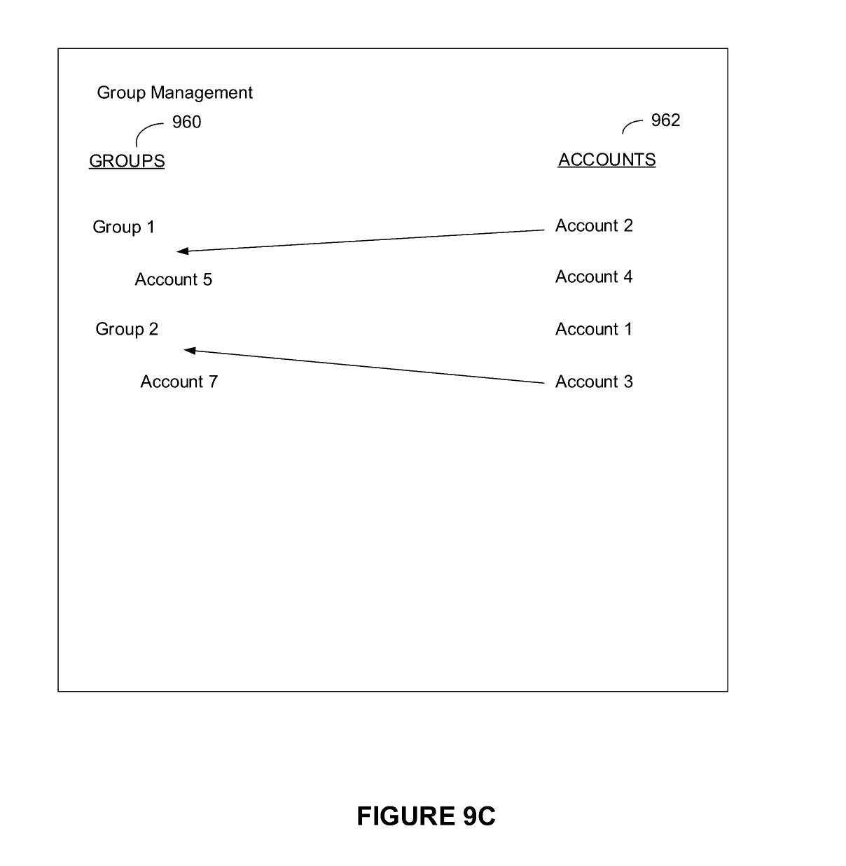

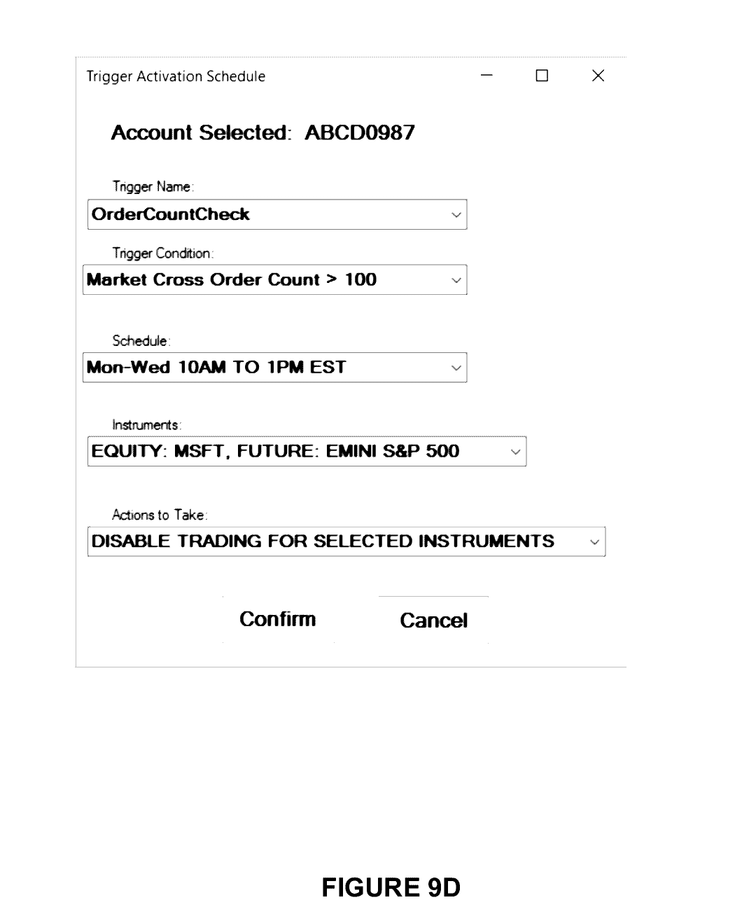

FIGS. 9A-D illustrate various graphical user interfaces (GUIs) associated with a trading platform and example risk control engine in accordance with embodiments. The GUIs may present information associated with trading platforms on a display screen of the client station. The GUI also enables a user to configure when orders associated with a trading algorithm may be adjusted.

FIG. 9A illustrates an example GUI with a single, aggregated view of information from multiple ISVs/trading platforms. This provides a holistic view for a user, account, group of accounts, and/or a trading firm. A desired view may be selectable via a tab 920. The tab enables showing views based on a group, user, or account. In the GUI, the GROUP is selected, resulting in a view based on groups. Additionally, a platform associated with the user, account, group, and/or trading firm may be identified by a code such as TT or FIX.

Information such as risk limits, e.g., a P&L when an account is liquidated, and positions across the plurality of trading platforms may be shown. Also, this information may include an indication of whether trading is enabled, a group name, total P&L, highest P&L, and realized P&L. A trading platform may provide the information to the risk control engine client station via the communication links. Then, the risk control engine may aggregate the information from various trading platforms and send the aggregated information to the client station for display.

FIG. 9B illustrates an example GUI that enables a user to set thresholds or patterns for when orders associated with a trading algorithm is adjusted. The thresholds or patterns may relate to parameters such as P&L, orders per minute, orders per second, P&L change per minute, number of consecutive orders, total quantity of new orders sent within a specified time period, etc. Referring to FIG. 9B, a parameter may be chosen, such as “P&L IS LESS THAN” from a list of parameters. Additionally, a threshold may be set such as 100. If the parameter satisfies the threshold, then an action may be taken. For example, the action may be to “Do Not Send Buy Orders” or “Block Buy Order Requests”. Further, the action may be taken at various sources such as at at trading algorithm level or the pre-trade risk control level selected from a list of sources. Similarly, the action may be chosen from a list of actions.

In some embodiments, the application may display the baseline parameters to the user, and the user may then use these baseline parameters to manually configure thresholds or patterns for remedial actions associated with a trading algorithm, a trading algorithm associated with a user, a trading algorithm associated with an account, a trading algorithm associated with a group, and/or a trading algorithm associated with a firm. These thresholds may be sent from the client station to the risk control engine via the communication links to effect the desired operation.

FIG. 9C illustrates an example GUI for group management. Users can create a group having certain common preferences. The preferences may be a specific risk profile or preferences such as using manual traders, setting behavior/profiles of algorithms, or using high frequency traders. In this regard, orders sent to the exchange may need to match the group preferences. The GUI in FIG. 9C shows how to create the groups. The left side has a hierarchical view of groups 960. On the right side 962 all possible users and accounts are available to add to the group. The arrows allow selected users/accounts from the right window to be added to the selected group on the left window. Other variations are also possible.

FIG. 9D illustrates an example GUI for trigger management. Various conditions associated with a trigger may be set. For example, a condition may be set that an order count greater than 100 satisfies a trigger. Additionally, the condition associated with satisfying a trigger may include the condition being at a certain time, e.g., Monday to Wednesday from 10 am to 1 pm EST. Further, adjustments associated with the trigger, e.g., “disable trading”, may be set, depending on the instrument type, e.g., equity. The conditions and actions may be set via drop down menus or other selection mechanisms.

III. Example Method

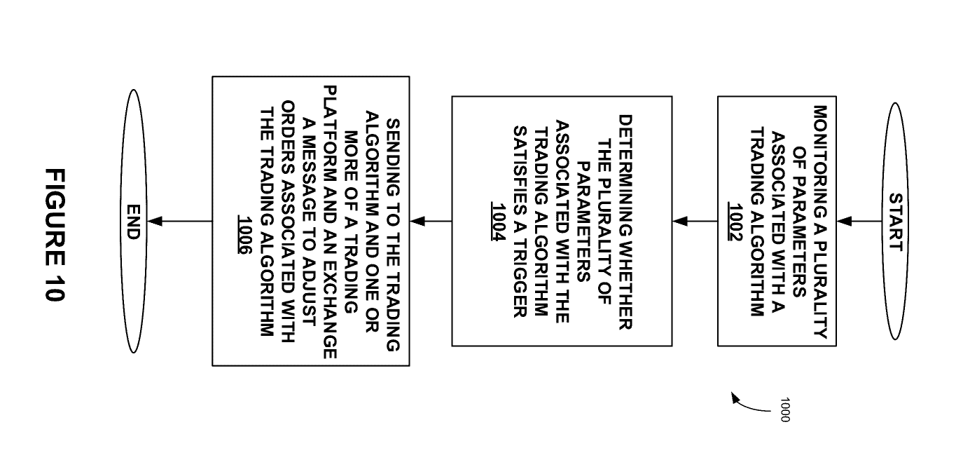

Turning now to FIG. 10, a flow diagram is depicted illustrating an example method 1000 for adjusting trading associated with a trading algorithm. For the method 1000, the operations illustrated by the blocks in the flow diagrams may be performed in line with the above discussion and by one or more of the risk control engine, trading platform, and/or exchange. Moreover, one or more operations discussed above may be added to a given flow diagram.

At 1002, a plurality of parameters associated with a trading algorithm may be monitored. At 1004, based on the monitoring, a determination is made whether the plurality of parameters associated with the trading algorithm satisfies a trigger. At 1006, based on the plurality of parameters satisfying the trigger, a message may be sent to the trading algorithm and one or more of a trading platform and an exchange to adjust orders associated with the trading algorithm.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided may not be the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

To the extent that examples described herein involve operations performed or initiated by actors, such as “humans”, “operators”, “users” or other entities, this is for purposes of example and explanation only. Further, the term “fluid” may refer to one type of fluid or multiple types of fluid. Moreover, the claims should not be construed as requiring action by such actors unless explicitly recited in the claim language.

We claim:

1. A method comprising:
monitoring a plurality of parameters associated with a trading algorithm;
based on the monitoring, determining whether the plurality of parameters associated with the trading algorithm satisfies a trigger; and
based on the plurality of parameters satisfying the trigger, sending to the trading algorithm and one or more of a trading platform and an exchange a message to adjust orders associated with the trading algorithm.

2. The method of claim 1, wherein the message is an indication to prohibit orders by the trading algorithm which increase risk of loss and allow orders by the trading algorithm which decrease risk of loss.

3. The method of claim 1, wherein sending a message to a trading algorithm comprises adjusting the orders associated with the trading algorithm while not adjusting orders of other trading algorithms.

4. The method of claim 1, wherein the message causes a state of the trading platform to change from a trading allowed state to a limited trading state.

5. The method of claim 1, wherein sending, via the network interface, to the trading algorithm and one or more of the trading platform and the exchange a message comprises:
sending a message to the trading platform to cancel orders associated with the trading algorithm or liquidate positions of an account associated with the trading algorithm;
setting a timer;
determining that the timer expired; and
based on the determination that the timer expired, disabling a type of trading associated with the trading algorithm.

6. The method of claim 1, wherein the trigger is satisfied when the plurality of parameters associated with the trading algorithm matches a predetermined pattern.

7. The method of claim 1, wherein the trigger is satisfied when the plurality of parameters associated with the trading algorithm is outside a range defined by a low value and a high value.

8. The method of claim 7, wherein the plurality of parameters outside the range comprises the plurality of parameters being outside the range by at least one standard deviation.

9. The method of claim 1, wherein sending, via the network interface, to the trading algorithm and one or more of the trading platform and the exchange a message comprises:
sending a first message to the trading algorithm, the first message instructing the trading algorithm to cancel orders or liquidate instruments of an account associated with the trading algorithm;
setting a timer;
determining that the timer expired and a position of the account associated with the trading algorithm is non-zero; and
based on determining that the timer expired and the position of the account associated with the trading algorithm is non-zero, sending a second message to zero out the position of the account; and
disabling a type of trading associated with the trading algorithm.

10. The method of claim 1, further comprising facilitating customization of actions associated with the adjusting of the orders for an account.

11. The method of claim 1, wherein the message to adjust orders causes the orders to not be sent to the exchange.

12. The method of claim 1, wherein sending, via the network interface, to the trading algorithm and one or more of the trading platform and the exchange a message comprises sending the message to a pre-trade risk check of the trading platform.

13. A network device comprising:
a network interface for communicating via a communication network with a trading platform, trading algorithm, and exchange; and
a processor comprising instructions, which when executed, cause the processor to:
monitor, via the network interface, a plurality of parameters associated with the trading algorithm;
based on the monitoring, determine whether the plurality of parameters associated with the trading algorithm satisfies a trigger; and
based on the plurality of parameters satisfying the trigger, send, via the network interface, to the trading algorithm and one or more of the trading platform and the exchange a message to adjust orders associated with the trading algorithm.

14. The network device of claim 13, wherein a message is an indication to prohibit orders by the trading algorithm which increase risk of loss and allow orders by the trading algorithm which decrease risk of loss.

15. The network device of claim 13, wherein the message causes a state of the trading platform to change from a trading allowed state to a limited trading state.

16. The network device of claim 13, wherein the instructions for sending, via the network interface, to the trading algorithm and one or more of the trading platform and the exchange a message comprises:
sending a message to the trading platform to cancel orders associated with the trading algorithm or liquidate positions of an account associated with the trading algorithm;
setting a timer;
determining that the timer expired; and
based on the determination that the timer expired, disabling a type of trading associated with the trading algorithm.

17. The network device of claim 13, wherein the trigger is satisfied when the plurality of parameters associated with the trading algorithm matches a predetermined pattern.

18. The network device of claim 13, wherein the instructions for sending, via the network interface, to the trading algorithm and one or more of the trading platform and the exchange a message comprises:
sending a first message to the trading algorithm, the first message instructing the trading algorithm to cancel orders or liquidate instruments of an account associated with the trading algorithm;
setting a timer;
determining that the timer expired and a position of the account associated with the trading algorithm is non-zero; and
based on determining that the timer expired and the position of the account associated with the trading algorithm is non-zero, sending a second message to zero out the position of the account; and
disabling a type of trading associated with the trading algorithm.

19. The network device of claim 13, further comprising instructions for facilitating customization of actions associated with the adjusting of the orders for an account.

20. The method of claim 1, wherein the trigger is satisfied based on the time of day.

21. The method of claim 1, wherein the message includes an indication to adjust orders based on a time of day.

22. The method of claim 1, wherein the trigger is based on market conditions.

23. The method of claim 1, wherein the message includes an indication to adjust orders based on risk.
